(19) United States
(12) Patent Application Publication
(10) Pub. No.: US 2016/0236217 A1
(43) Pub. Date: Aug. 18, 2016

(54) Power Sprayer

(71) Applicant: Bond Manufacturing Co., Inc., Antioch, CA (US)

(72) Inventor: James C. Jenkins, Marco Island, FL (US)

(73) Assignee: Bond Manufacturing Co., Inc., Antioch, CA (US)

(21) Appl. No.: 14/624,551

(22) Filed: Feb. 17, 2015

(51) Int. Cl. B05B 9/04; B05B 9/01

(52) U.S. Cl. CPC B05B 9/0426; B05B 9/01

(57) ABSTRACT

Provided herein are, among other things, a power sprayer comprising a housing, a trigger, a battery, a pump switch, a hose connector, a spray nozzle having a spray inlet and a spray outlet, a valve having a valve inlet and a valve outlet, a motor powered pump within the housing having a pump inlet and a pump outlet, wherein the valve outlet is in fluid communication with the spray nozzle inlet, the pump outlet is in fluid communication with the valve inlet, the pump inlet is in fluid communication with the hose connector, and the pump switch is electrically coupled to the motor powered pump and the battery.

### FIELD OF THE INVENTION

Provided herein is a power sprayer comprising a housing, a trigger, a battery, a pump switch, a hose connector, a spray nozzle having a spray inlet and a spray outlet, a valve having a valve inlet and a valve outlet, a motor powered pump within the housing having a pump inlet and a pump outlet, wherein the valve outlet is in fluid communication with the spray nozzle inlet, the pump outlet is in fluid communication with the valve inlet, the pump inlet is in fluid communication with the hose connector, and the pump switch is electrically coupled to the motor powered pump and the battery.

### BACKGROUND OF THE INVENTION

Sprayers have long been used to spray liquids (e.g., water) for various applications such as watering plants and washing vehicles (e.g., cars and boats). Many of the sprayers are configured to be powered by the household water pressure and require users to squeeze a trigger to activate the water flow. The major problems with this type of sprayers are that (a) it is difficult to control the levels of flow rate and water pressure by squeezing the trigger; and (b) the maximum water pressure is limited by the household water pressure, which is generally from 30 to 80 psi.

Sprayers powered by pumps are available in the market. However, most of the power sprayers include an external pump which is used to supply the pressure necessary to deliver a liquid to a hand held sprayer used for application of the liquid. The major problem with this type of sprayers is that it may be difficult to operate such type of sprayers because the operators have to manually operate two devices (i.e., the pump and hand held sprayer) separately.

Some power sprayers include a housing and a spray nozzle with a pump and a battery inside the housing. Generally, this type of power sprayers further comprises a connector adapted to couple to the top opening of a liquid container. The major problems with this type of sprayers are that (a) the housing has to be opened when the battery needs to be replaced or recharged; and (b) they are not designed for connecting with a spigot or a tap.

Therefore, there is a need for a power sprayer that can provide water pressure higher than the household water pressure such as greater than 80 psi. There is also a need for a power sprayer with the pump and the sprayer nozzle in one single unit for easy operation. There is also a need for a garden hose power sprayer that has a detachable battery that can be easily detached from the housing of the power sprayer and be recharged conveniently and safely.

### SUMMARY OF THE INVENTION

Provided herein is a power sprayer that that can provide water pressure higher than the household water pressure. Also provided herein is a power sprayer having a pump and a sprayer nozzle in one single unit for easy operation. Also provided herein is a garden hose power sprayer that has a detachable battery that can be easily detached from the housing and be recharged conveniently and safely.

In one aspect, provided herein is a power sprayer comprising:

a) a housing, wherein the housing comprises a handle portion which is configured to be gripped by an operator of the power sprayer;

b) a hose connector coupled to the housing, wherein the hose connector is configured to connect with an external hose;

c) a spray nozzle coupled to the housing, wherein the spray nozzle comprises a spray nozzle outlet and a spray nozzle inlet;

d) a valve within the housing having a valve inlet and a valve outlet, wherein the valve is configured to be operable between an open position and a closed position, and wherein the valve outlet is in fluid communication with the spray nozzle inlet;

e) a trigger slidably or pivotally mounted in the handle portion, wherein the trigger controls the movement of the valve between the open position and the closed position;

f) a motor powered pump within the housing having a pump inlet and a pump outlet, wherein the pump inlet is in fluid communication with the hose connector, and wherein the pump outlet is in fluid communication with the valve inlet;

g) a battery detachably coupled to an outside surface of the housing; and

h) a pump switch coupled to the housing, wherein the pump switch is electrically coupled to the motor powered pump and the battery.

In some embodiments, the power sprayer further comprises a movable panel forming a wall of the housing, wherein the movable panel comprises a dispenser for dispensing a liquid or chemical such as soaps, detergents or waxes. In one embodiment, the dispenser is for dispensing a soap or detergent. In certain embodiments, the power sprayer further comprises a dispenser switch configured to be operable between an open position for opening the dispenser and a closed position for closing the dispenser. In other embodiments, the power sprayer further comprises a sight gauge for observing the level of the liquid in the dispenser. In further embodiments, the dispenser is in fluid communication with the spray nozzle inlet, the valve outlet, the valve inlet or the pump outlet.

In certain embodiments, the spray nozzle is a compound nozzle, wherein the compound nozzle comprises a plurality of nozzles, and wherein each of the nozzles is configured to deliver a set of spray characteristics different from those of the other nozzles. In some embodiments, the spray nozzle comprising a rotatable nozzle having a plurality of orifices, and wherein each of the orifices is configured to deliver a set of spray characteristics different from those of the other orifices. In other embodiments, the spray nozzle is a two-fluid nozzle having a spray nozzle outlet and two spray nozzle inlets, wherein the valve outlet is in fluid communication with one of the spray nozzle inlets and the dispenser is in fluid communication with the other spray nozzle inlet.

In some embodiments, the power sprayer further comprises a trigger guide coupled to the handle portion, wherein the trigger slidably runs on the trigger guide.

In certain embodiments, the pump inlet is connected by a first hose to the hose connector and the pump outlet is connected by a second hose to the valve inlet. In some embodiments, the inside diameter of each of the first and second hoses is independently 0.375 inches (9.525 mm), 0.5 inches (12.7 mm), or 0.625 inches (15.875 mm).

In some embodiments, the battery is a rechargeable battery. In certain embodiments, the rechargeable battery comprises one or a plurality of lithium-ion batteries or cells. In other embodiments, the power sprayer further comprises an electrical contact base at a bottom portion of the housing, wherein the battery detachably coupled to the housing by coupling with the outside surface of the electrical contact base.

In certain embodiments, the motor powered pump is configured to provide at the spray nozzle outlet or the pump outlet a water pressure of at least 60 psi, at least 80 psi, at least 100 psi, at least 120 psi or at least 130 psi and a flow rate of at least 1 liter per minute, at least 2 liters per minute, at least 3 liters per minute, at least 4 liters per minute, or at least 5 liters per minute. In some embodiments, the valve is a plunger valve or a shuttle valve.

In some embodiments, the power sprayer further comprises a pressure sensor coupled to the handle portion for sensing the gripping pressure by an operator on the sensor or the trigger. In certain embodiments, the pressure sensor electrically coupled to the trigger and/or the motor powered pump such that when the pressure on the trigger or the pressure sensor is below a pre-determined level, the motor powered pump is shut off. In some embodiments, the pre-determined level is zero pressure.

In certain embodiments, the power sprayer further comprises an external hose connected with the hose connector for siphoning water from a container or a natural body of water.

In some embodiments, the power sprayer further comprises a splash guard between the hose connector and the battery for keeping water away from the battery.

In certain embodiments, the power sprayer works like a standard hose sprayer when the pump is not powered by the battery.

### DESCRIPTION OF THE DRAWINGS

FIG. 1 depicts a perspective view of an embodiment of the power sprayer disclosed herein.

FIG. 2 depicts a partially cut-away view of the embodiment of the power sprayer as shown in FIG. 1.

FIG. 3 depicts a front view of the embodiment of the power sprayer as shown in FIG. 1.

FIG. 4 depicts a top view of the embodiment of the power sprayer as shown in FIG. 1.

FIG. 5 depicts a bottom view of the embodiment of the power sprayer as shown in FIG. 1.

FIG. 6 depicts a perspective view of another embodiment of the power sprayer disclosed herein.

### DEFINITIONS

The term “hose” or “hosepipe” or “garden hose” refers to a flexible tube used to convey water. Hoses may be made of synthetic rubbers, soft plastics and combinations thereof, optionally reinforced with an internal web of fibers. In certain embodiments, the internal diameter of the hose is 0.25 inches (6.35 mm), 0.375 inches (9.525 mm), 0.5 inches (12.7 mm), 0.625 inches (15.875 mm), 0.75 inches (19.05 mm), 0.875 inches (22.225 mm) or 1 inch (25.4 mm). In some embodiments, the internal diameter of the hose is from about 0.25 inches (6.35 mm) to about 1 inch (25.4 mm), or from 0.25 inches (9.525 mm) to 0.75 inches (19.05 mm), or from 0.375 inches (9.525 mm) to 0.625 inches (15.875 mm). A hose generally comprises two ends respectively having a male connecter and a female connecter. One of the two ends can be mated to or connected with a hose appliance, such as the sprayers disclosed herein, and the other end can be mated to or connected with another hose, a spigot, a faucet or a tap. In some embodiments, the male connecter and female connecter of the hoses disclosed herein comprise male and female thread respectively, wherein a small rubber or plastic washer is used in the female end to prevent leakage. In other embodiments, the male and female connecters comprise quick-connector systems, such as a snap-fit system, which allow hoses and accessories to be easily connected together or disconnected.

The term “hose connector” refers to a connector at the end of a hose or hose appliance, such as the sprayers disclosed herein, for connecting or coupling it with another hose, or a spigot or a hose appliance. The hose connector is generally made of brass, aluminum, a steel (e.g., stainless steel, carbon steel or alloy steel), or a plastic. Hose connectors can be either male connecters or female connecters wherein the male connecter couples or mates only with the corresponding female connecter and vice versa.

The term “hose union” refers to the coupling or mating of a male connector to a female connector.

The term “hose coupler” refers to a pair of male and female hose connectors that form a hose union.

The term “spigot” or “faucet” or “tap” refers to a valve for controlling the release of water. In some embodiments, the spigot or faucet or tap comprises a thread or a connector for having a hose union with a hose disclosed herein. In certain embodiments, the spigot, faucet or tap generally has a male connector and the hose has a female connector which fits the male connector. In other embodiments, the spigot, faucet or tap generally has a female connector and the hose has a male connector which fits the female connector.

The term “spray nozzle” refers to a device that can discharge a liquid, such as water, in the form of a spray or a jet. In certain embodiments, the spray nozzle is a single-fluid nozzle for spraying water only. Some non-limiting examples of the single-fluid nozzle include shaped-orifice nozzles, surface-impingement single-fluid nozzles, pressure-swirl single-fluid spray nozzles, solid-cone single-fluid nozzles, and compound nozzles. In certain embodiments, the spray nozzle is a two-fluid nozzle for mixing and spraying water and a liquid soap or detergent. Some non-limiting examples of the two-fluid nozzle include internal-mix two-fluid nozzles and external-mix two-fluid nozzles.

The term “compound nozzle” refers to a nozzle which comprises several individual single-fluid nozzles or orifices and/or two-fluid nozzles.

The term “valve” refers to a device that can regulate, direct or control the flow of a fluid (e.g., gases, liquids, fluidized solids, or slurries) by opening, closing, or partially obstructing one or more passages inside the valve.

The term “valve port” refers to a passage that allows fluid to pass through a valve. A port can be opened, closed or partially obstructed by a valve member to control flow.

The term “trigger” refers to a device that, when manually activated, actuates flowing or discharging of a fluid such as water. In some embodiments, the trigger comprises a lever or button actuated by one or more fingers such as the index finger, thumb and weak fingers.

The term “pump” refers to a device that moves fluids (such as liquids or gases) by mechanical action.

The term “motor powered pump” refers to a pump that is powered by an electrical motor. Some non-limiting examples of the motor powered pump include positive displacement pumps, impulse pumps, velocity pumps gravity pumps, steam pumps, and valveless pumps. Some non-limiting examples of the positive displacement pumps include rotary positive displacement pump, reciprocating positive displacement pump, gear pump, screw pump, progressing cavity pump, roots-type pump, peristaltic pump, plunger pump, triplex-style plunger pump, diaphragm pump, compressed-air-powered double-diaphragm pump, rope pumps, flexible impeller pump.

The term “battery” refers to a device comprising one or more electrochemical cells that convert stored chemical energy into electrical energy. Some non-limiting examples of the battery include primary batteries and secondary batteries. The electrochemical cells can be galvanic cells, electrolytic cells, fuel cells, flow cells and voltaic piles.

The term “primary battery” refers to a battery that is designed to be used once and discarded, and not recharged with electricity and reused like a secondary cell. Some non-limiting examples of the primary battery or disposable battery include zinc-carbon batteries and alkaline batteries.

The term “secondary battery” refers to a rechargeable battery where its electrochemical reactions are electrically reversible. The secondary battery or rechargeable batteries can come in many different shapes and sizes, ranging from button cells to megawatt systems connected to stabilize an electrical distribution network. Some non-limiting examples of the secondary battery or rechargeable battery include lead-acid, nickel cadmium (NiCd), nickel metal hydride (NiMH), lithium ion (Li-ion), and lithium ion polymer (Li-ion polymer).

The term “sight gauge” refers to a device which allows an observer to observe the level of fluids in a system. Some non-limiting examples of the sight gauge include transparent panels or tubes made of a plastics or glass.

The term “household water pressure” refers to the water pressure at a normal household spigot or tap. In some embodiments, the household water pressure is from 30 psi to 40 psi, from 30 psi to 50 psi, from 30 to 60 psi, from 30 to 70 psi, or from 30 to 80 psi.

### DESCRIPTION OF EMBODIMENTS OF THE INVENTION

Provided herein are power sprayers that can be used for various applications such as watering plants and washing vehicles. In some embodiments, the power sprayers spray water on an object so as to distribute water over an area of the object, to increase water surface area, and to create impact force of water on a surface of the object for, inter alia, cleaning the surface.

In one aspect, provided herein is a power sprayer comprising:

a) a housing, wherein the housing comprises a handle portion which is configured to be gripped by an operator of the power sprayer;

b) a hose connector coupled to the housing, wherein the hose connector is configured to connect with an external hose;

c) a spray nozzle coupled to the housing, wherein the spray nozzle comprises a spray nozzle outlet and a spray nozzle inlet;

d) a valve within the housing having a valve inlet and a valve outlet, wherein the valve is configured to be operable between an open position and a closed position, and wherein the valve outlet is in fluid communication with the spray nozzle inlet;

e) a trigger slidably or pivotally coupled to the handle portion, wherein the trigger controls the movement of the valve between the open position and the closed position;

f) a motor powered pump within the housing having a pump inlet and a pump outlet, wherein the pump inlet is in fluid communication with the hose connector, and wherein the pump outlet is in fluid communication with the valve inlet;

g) a battery detachably coupled to an outside surface of the housing; and

h) a pump switch coupled to the housing, wherein the pump switch is electrically coupled to the motor powered pump and the battery.

The housing disclosed herein can be in any shape and size suitable to be used by an operator for spraying water. In some embodiments, the housing is in the shape of a pistol (e.g., Taurus CURVE™ pistol) or a staple gun. In certain embodiments, the housing comprises a handle portion which is configured to be gripped by an operator of the power sprayer disclosed herein. In other embodiments, the housing comprises the handle portion, a top portion, a bottom portion, optionally a front portion. In further embodiments, the top portion, bottom portion, front portion, and handle portion define an opening in the middle of the power sprayer disclosed herein, wherein the opening is configured to accommodate the fingers of the operator for gripping the handle portion. In some embodiments, the housing disclosed herein may be formed or made of one or more of plastics, composites, metals and combinations thereof.

Any hose connector that can connect or couple with a connector at the end of an external hose can be used for the power sprayer disclosed herein. In some embodiments, the hose connector is configured to connect with a hose having an internal diameter of 0.375 inches (9.525 mm), 0.5 inches (12.7 mm), 0.625 inches (15.875 mm), or 0.75 inches (19.05 mm), or from 0.375 inches (9.525 mm) to 0.625 inches (15.875 mm).

The spray nozzle disclosed herein can be any device that can discharge a liquid, such as water, in the form of a spray or a jet. The spray nozzle disclose herein comprises a spray nozzle outlet and a spray nozzle inlet. In certain embodiments, the spray nozzle is a shaped-orifice nozzle, a surface-impingement single-fluid nozzle, a pressure-swirl single-fluid spray nozzle, a solid-cone single-fluid nozzle, or a compound nozzle. In some embodiments, the spray nozzle is a compound nozzle comprises a plurality of nozzles or orifices, each of which has a unique set of spray characteristics such as spray pattern, flow rate, pressure, spray angle, spray drop size or a combination thereof. In other embodiments, the spray nozzle is a compound nozzle comprises a rotatable nozzle or plate having a plurality of orifices, each of which has a unique set of spray characteristics. In further embodiments, the spray characteristics of each of the plurality of nozzles or each of the plurality of orifices are different from each other.

The spray pattern provided by the spray nozzle outlet or each of the orifices can be independently any spray pattern suitable for a specific sprayer application. In some embodiments, the spray pattern of each of the orifices is independently in the form of solid stream, hollow cone, full cone, or flat spray.

The flow rate of the spray nozzle outlet or each of the orifices can be independently any flow rate suitable for a specific sprayer application. In some embodiments, the flow rate of each of the orifices independently is from 0 to at least 50 liters per minute, from 0 to at least 40 liters per minute, from 0 to at least 30 liters per minute, or from 0 to at least 20 liters per minute, from 0 to at least 10 liters per minute, or from 0 to at least 5 liters per minute. In certain embodiments, the flow rate at each of the orifices is independently at least 1 liter per minute, at least 2 liters per minute, at least 3 liters per minute, at least 4 liters per minute, or at least 5 liters per minute.

The water pressure at the spray nozzle outlet or each of the orifices can be independently any water pressure suitable for a specific sprayer application. In some embodiments, the water pressure at each of the orifices is independently from 0 to 200 psi, from 0 to 150 psi, from 0 to 130 psi, from 0 to 120 psi, from 0 to 100 psi, from 0 to 80 psi, from 0 to 60 psi, from 0 to 50 psi, from 0 to 30 psi, from 0 to 20 psi, or from 0 to 10 psi. In certain embodiments, the water pressure at each of the orifices is independently at least 10 psi, at least 20 psi, at least 30 psi, at least 40 psi, at least 50 psi, at least 60 psi, at least 80 psi, at least 100 psi, at least 120 psi or at least 130 psi. Generally, solid stream or narrow spray angle flat fan spray pattern are used for high pressure applications such as cleaning.

The spray angle provided by the spray nozzle outlet or each of the orifices can be independently any spray angle suitable for a specific sprayer application. In some embodiments, the spray angle provided by each of the orifices is independently less than 180 degrees, less than 160 degrees, less than 135 degrees, less than 120 degrees, less than 90 degrees, less than 60 degrees, less than 45 degrees, less than 30 degrees, less than 20 degrees, less than 15 degrees, less than 10 degrees, or less than 5 degrees. In certain embodiments, the spray angle provided by each of the orifices is independently more than 180 degrees, more than 160 degrees, more than 135 degrees, more than 120 degrees, more than 90 degrees, more than 60 degrees, more than 45 degrees, more than 30 degrees, more than 20 degrees, more than 15 degrees, more than 10 degrees, or more than 5 degrees.

The spray drop size provided by the spray nozzle outlet or each of the orifices can be independently any spray drop size suitable for a specific sprayer application. In some embodiments, the spray pattern is a solid stream which provides no or insignificant proportion of droplets. In certain embodiments, the spray pattern is hollow cone, full cone, or flat spray which provides droplets or spray drops. The spray drop size can be expressed in term of Sauter mean diameter (SMD), volume median diameter (VMD) or mass median diameter (MMD). In some embodiments, the SMD, VMD or MMD of the spray drop size provided by some of the orifices is independently less than 1000 micrometers, less than 100 micrometers, less than 10 micrometers, or less than 1 micrometer. In certain embodiments, the SMD, VMD or MMD of the spray drop size provided by some of the orifices is independently greater than 1000 micrometers, greater than 100 micrometers, greater than 10 micrometers, or greater than 1 micrometer.

The valve disclosed herein can be any device that can regulate, direct or control the flow of a fluid (e.g., water and liquid soap) by opening, closing, or partially obstructing one or more passages inside the valve. The valve disclosed herein is configured to be operable between an open position and a closed position, including a partially obstructed position. Some non-limiting examples of the valve include ball valve, butterfly valve, ceramic disc valve, check valve or non-return valve, diaphragm valve, gate valve, globe valve, knife valve, needle valve, plug valve, flow control valve, shuttle valve, and plunger valve. In some embodiments, the valve is a plunger valve or a shuttle valve. The valves disclosed herein may have 2 ports, 3 ports, 4 ports or multiple ports. In some embodiments, the valve disclosed herein is a 2-port valve having a valve inlet and a valve outlet, wherein the valve outlet is in fluid communication with the spray nozzle inlet.

The trigger disclosed herein can be any device that, when manually activated, actuates flowing or discharging of a fluid such as water. In some embodiments, the power sprayer further comprises a trigger guide coupled to the housing, wherein the trigger slidably runs on the trigger guide. In certain embodiments, the trigger controls the movement of the valve between the open position and the closed position. In further embodiments, the trigger actuates the pump switch so that when the trigger is activated, energy is supplied from the battery to actuate the motor powered pump to thereby pump a liquid (e.g., water) supplied by the external hose and discharge the liquid out the power sprayer.

In some embodiments, the trigger controls water flow, regardless of the battery's state of charge. In certain embodiments, the power sprayer works like a standard hose sprayer when the pump is not powered by the battery, for example, the battery is completely discharged or removed. In other embodiments, the trigger controls the valve and is mechanically linked to the valve with a cord and pulley. The valve may be spring-loaded in the closed position. When the trigger is pulled, the valve opens and allows water to flow. In some embodiments, when the battery is charged and the pump switch is in the open position, water flows at a pressure higher than the household water pressure. In certain embodiments, when the battery is discharged or removed, the power sprayer functions like a standard hose sprayer and water flows at household water pressure.

In some embodiments, the flow rate can be controlled by the orifices or the nozzles of the spray nozzle. In certain embodiments, the volume of water can be controlled by the position of the valve. In other embodiments, the water pressure can be controlled by performance specifications of the motor powered pump.

The motor powered pump disclosed herein can be any device that moves fluids by mechanical action and is powered by an electrical motor. The motor powered pump is within the housing having a pump inlet and a pump outlet, wherein the pump inlet is in fluid communication with the hose connector, and wherein the pump outlet is in fluid communication with the valve inlet. In some embodiments, the motor powered pump comprises a motor, a pump and a transmission or gear box coupled to the motor and the pump, wherein the motor drives the transmission, which in turn drives the pump. In some embodiments, the motor powered pump is a diaphragm pump. In certain embodiments, the motor powered pump is a 12 or 24 vdc pump.

In some embodiments, the motor powered pump is designed to provide a water pressure from 50 to 200 psi, from 50 to 150 psi, from 50 to 130 psi, from 50 to 120 psi, from 50 to 100 psi, or from 50 to 80 psi. In certain embodiments, the motor powered pump is designed to provide a water pressure of at least at least 50 psi, at least 60 psi, at least 80 psi, at least 100 psi, at least 120 psi, at least 130 psi, at least 140 psi, at least 150 psi or at least 160 psi.

The battery disclosed herein can be any device that comprises one or more electrochemical cells that convert stored chemical energy into electrical energy. In some embodiments, the battery is a secondary battery or rechargeable battery. In certain embodiments, the battery is a nickel cadmium (NiCd), nickel metal hydride (NiMH), lithium ion (Li-ion), and lithium ion polymer (Li-ion polymer). In certain embodiments, the battery is a battery pack comprising nickel cadmium (NiCd) cells, nickel metal hydride (NiMH) cells, lithium ion (Li-ion) cells, lithium ion polymer (Li-ion polymer) cells and combinations thereof. In some embodiments, the battery is a battery pack comprising lithium ion (Li-ion) cells, such as Samsung INR18650-15L cells.

In certain embodiments, the pump switch is electrically coupled to the motor powered pump and the battery. In some embodiments, the pump switch is electrically coupled to the motor powered pump, the battery and the trigger or the trigger circuit. In further embodiments, the pump switch makes battery power available to the trigger circuit which then excites the motor powered pump when the trigger is pulled. The pump switch can be either inside the housing or protrude outside the housing.

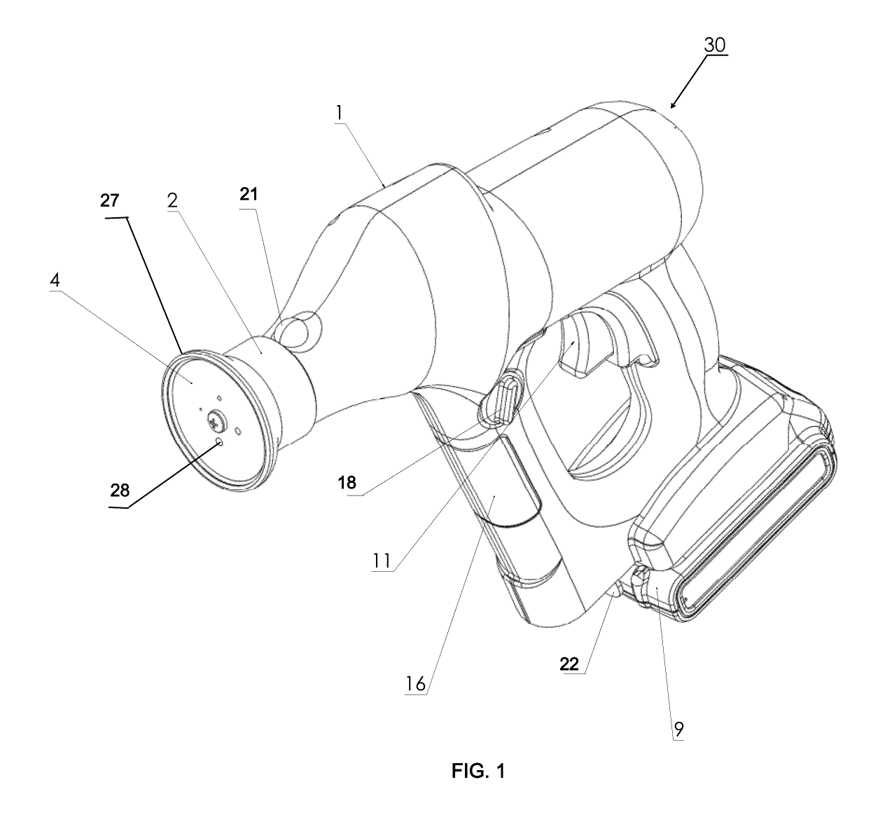

FIG. 1 depicts a perspective view of an embodiment of the power sprayer (30) disclosed herein comprising housing (1), spray nozzle (2) coupled to housing (1), wherein the spray nozzle comprises rotatable nozzle or compound nozzle (4) having a plurality of orifices or nozzles (28), spray nozzle outlet (27) and a spray nozzle inlet (not shown), valve chamber (21) for accommodating a range of motion for a valve (not shown), trigger (11) slidably runs on a trigger guide (not shown) which is coupled to housing (1), battery (9) detachably coupled to an outside surface of housing (1), movable panel (16) forming a wall of housing (1), dispenser switch (18) configured to be operable between an open position for opening a dispenser (not shown) and a closed position for closing the dispenser, and splash guard (22) between a hose connector (not shown) and battery (9) for keeping water away from battery (9). The housing can be made of a composite, a polymer, or a metal such as stainless steel.

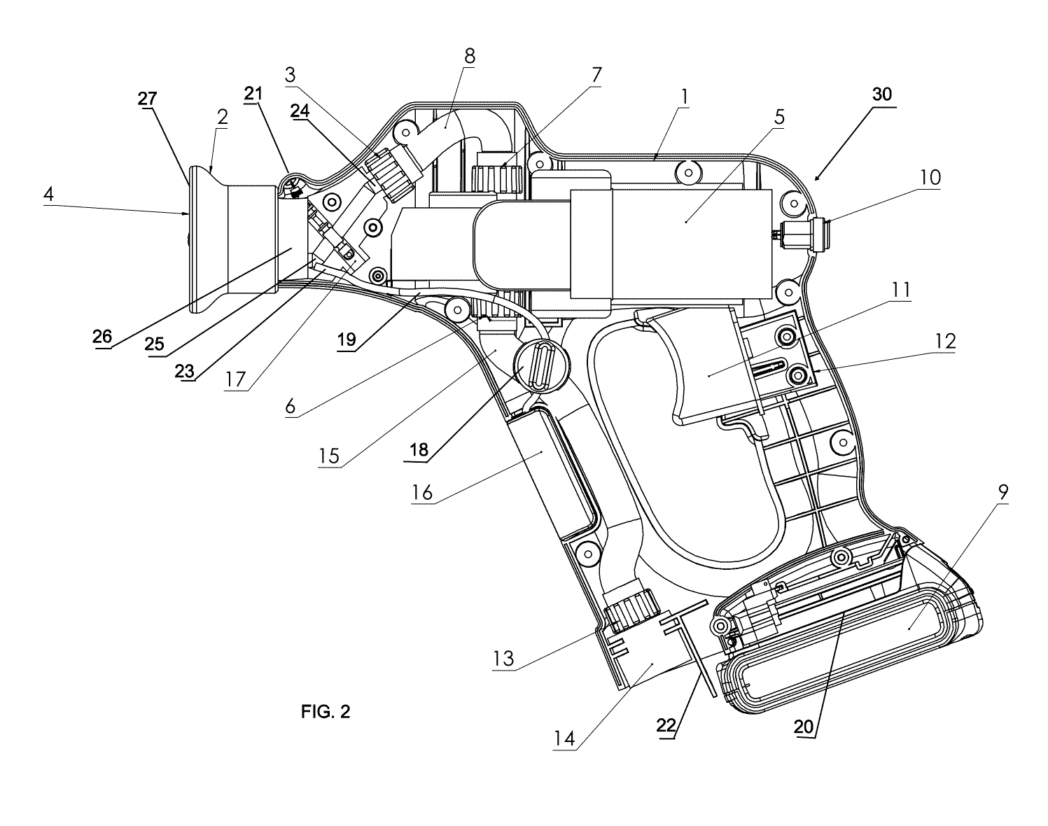

FIG. 2 depicts a partially cut-away view of the embodiment of the power sprayer as shown in FIG. 1 comprising housing (1), spray nozzle (2) coupled to housing (1), wherein the spray nozzle comprises rotatable nozzle or compound nozzle (4) having a plurality of orifices or nozzles (28), spray nozzle outlet (27) and a spray nozzle inlet (26), a valve (17) within housing (1) having valve inlet (24) and valve outlet (25), wherein valve outlet (25) is in fluid communication with spray nozzle inlet (26), valve chamber (21) for accommodating a range of motion for valve (17), trigger (11), trigger guide (12) coupled to housing (1), wherein trigger (11) slidably runs on trigger guide (12), motor powered pump (5) within housing (1) having pump inlet (6) and pump outlet (7), wherein pump inlet (6) is in fluid communication with hose connector (14) and pump outlet (7) is in fluid communication with valve inlet (24), battery (9) detachably coupled to an outside surface (20) of bottom portion (33) of housing (1), movable panel (16) forming a wall of housing (1), wherein the movable panel comprises a dispenser (not shown) and the dispenser is in fluid communication with valve outlet (25) using tube (19) having tube outlet (23), dispenser switch (18) configured to be operable between an open position for opening a dispenser (not shown) and a closed position for closing the dispenser, splash guard (22) between a hose connector (14) and battery (9) for keeping water away from battery (9), and pump switch (10) coupled to housing (1), wherein pump switch (10) is electrically coupled to motor powered pump (5) and battery (9). Pump inlet (6) is connected by hose (15) with hose connector (14) using hose coupler (13) and pump outlet (7) is connected by hose (8) with valve inlet (24) using hose coupler (3).

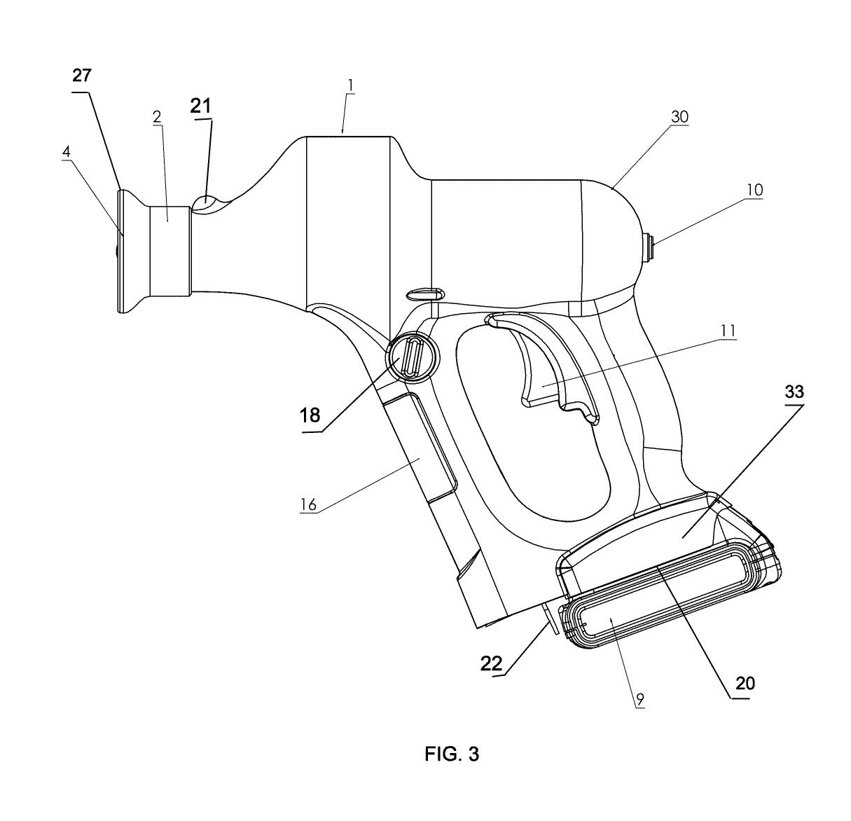

FIG. 3 depicts a front view of the embodiment of the power sprayer as shown in FIG. 1 showing housing (1), spray nozzle (2) coupled to housing (1), wherein the spray nozzle comprises rotatable nozzle or compound nozzle (4) having a plurality of orifices or nozzles (28) and spray nozzle outlet (27), valve chamber (21) for accommodating a range of motion for a valve (not shown), trigger (11) slidably runs on a trigger guide (not shown) which is coupled to housing (1), battery (9) detachably coupled to an outside surface (20) of bottom portion (33) of housing (1), movable panel (16) forming a wall of housing (1), dispenser switch (18) configured to be operable between an open position for opening a dispenser (not shown) and a closed position for closing the dispenser, and splash guard (22) between a hose connector (not shown) and battery (9) for keeping water away from battery (9).

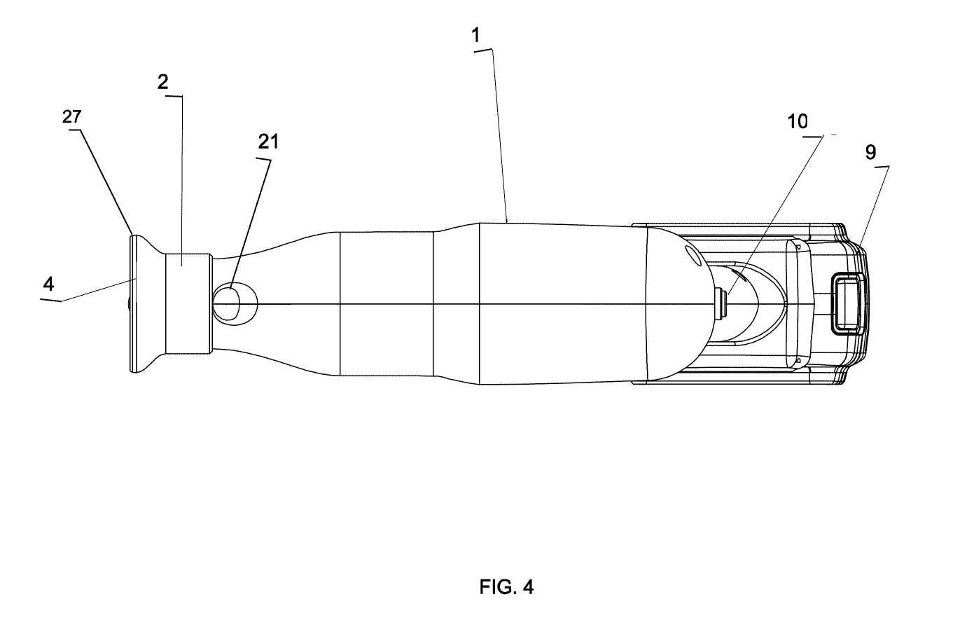

FIG. 4 depicts a top view of the embodiment of the power sprayer as shown in FIG. 1 showing housing (1), spray nozzle (2) coupled to housing (1), wherein the spray nozzle comprises rotatable nozzle or compound nozzle (4) and spray nozzle outlet (27), valve chamber (21) for accommodating a range of motion for a valve (not shown), battery (9) detachably coupled to an outside surface of housing (1), and pump switch (10) coupled to housing (1), wherein pump switch (10) is electrically coupled to a motor powered pump (not shown) and battery (9).

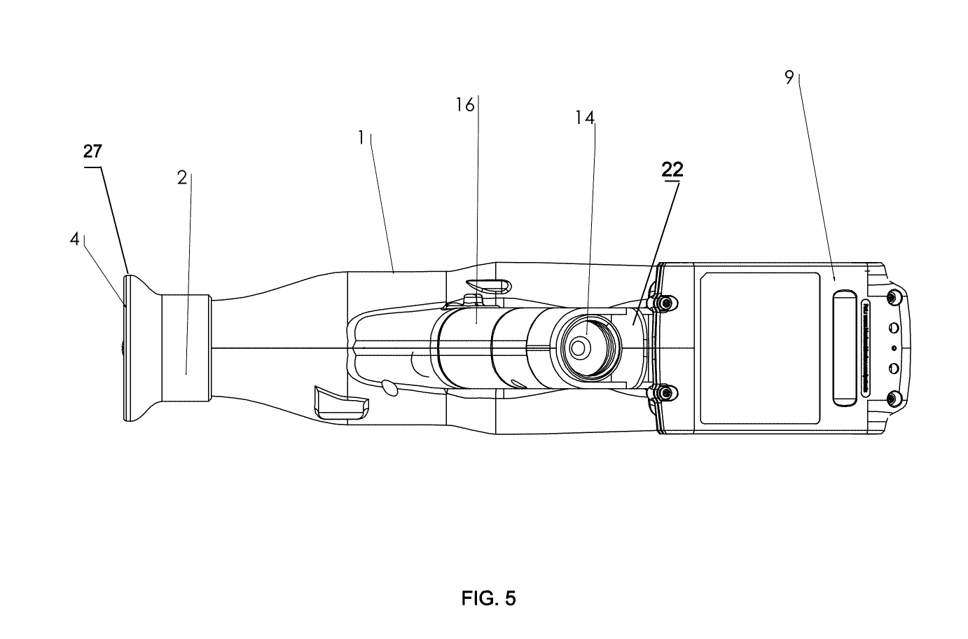

FIG. 5 depicts a bottom view of the embodiment of the power sprayer as shown in FIG. 1 showing housing (1), spray nozzle (2) coupled to housing (1), wherein the spray nozzle comprises rotatable nozzle or compound nozzle (4) and spray nozzle outlet (27), movable panel (16) forming a wall of the housing, battery (9), and splash guard (22) between hose connector (14) and battery (9) for keeping water away from the battery.

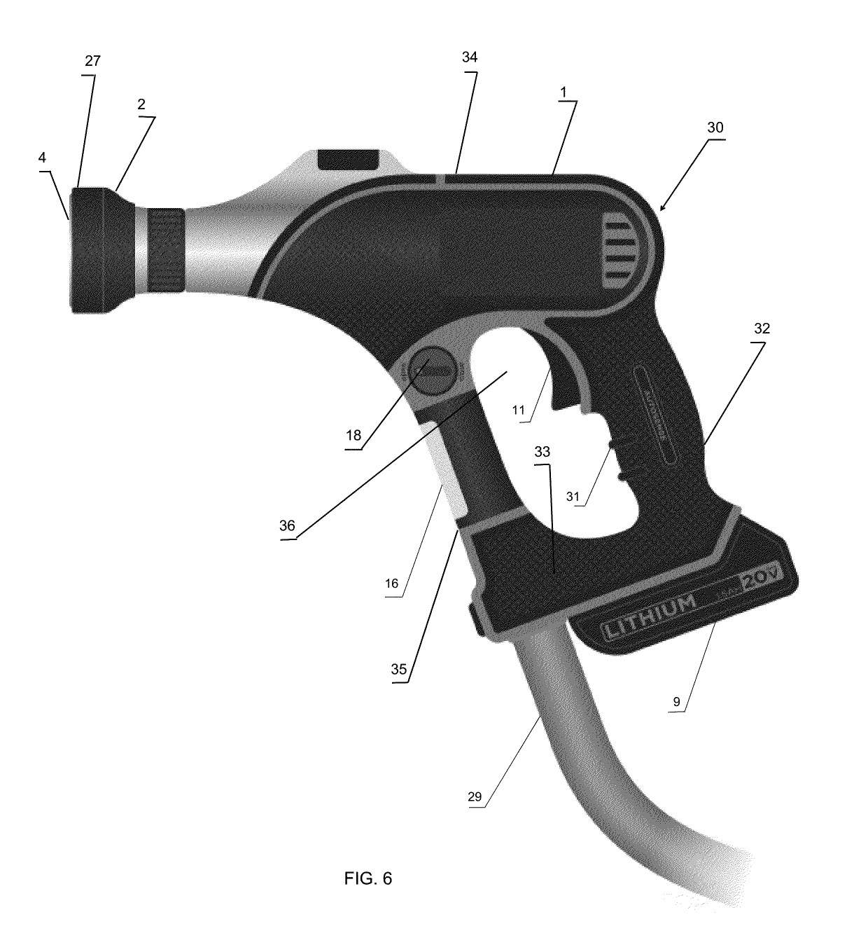

FIG. 6 depicts a perspective view of another embodiment of the power sprayer (30) disclosed herein comprising housing (1); spray nozzle (2) coupled to housing (1), wherein the spray nozzle comprises rotatable nozzle or compound nozzle (4) and spray nozzle outlet (27); handle portion (32); top portion (34); bottom portion (33); and front portion (35), wherein handle portion (32), top portion (34), bottom portion (33), and front portion (35) define or surround opening (36) configured to accommodate the fingers of an operator for gripping handle portion (32); trigger (11) slidably coupled to handle portion (32); pressure sensor (31) coupled to handle portion (32) for sensing the gripping pressure by the operator on pressure sensor (31) or trigger (11); battery (9) detachably coupled to an outside surface of housing (1); movable panel (16) forming a wall of housing (1); and dispenser switch (18) configured to be operable between an open position for opening a dispenser (not shown) and a closed position for closing the dispenser. The power sprayer (30) is connected to an external hose (29).

FIGS. 1-6 depicts just two non-limiting embodiments of the power sprayer disclosed herein. Variations and modifications from the embodiment exist.

As demonstrated above, embodiments of the invention provide power sprayers that that can be used for various applications such as watering plants and washing vehicles. While the invention has been described with respect to a limited number of embodiments, the specific features of one embodiment should not be attributed to other embodiments of the invention. No single embodiment is representative of all aspects of the invention. Variations and modifications from the described embodiments exist. The appended claims intend to cover all such variations and modifications as falling within the scope of the invention.

All publications and patent applications mentioned in this specification are herein incorporated by reference to the same extent as if each individual publication or patent application was specifically and individually indicated to be incorporated by reference. Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

What is claimed is:

1. A power sprayer comprising:
i) a housing, wherein the housing comprises a handle portion which is configured to be gripped by an operator of the power sprayer;
j) a hose connector coupled to the housing, wherein the hose connector is configured to connect with an external hose;
k) a spray nozzle coupled to the housing, wherein the spray nozzle comprises a spray nozzle outlet and a spray nozzle inlet;
l) a valve within the housing having a valve inlet and a valve outlet, wherein the valve is configured to be operable between an open position and a closed position, and wherein the valve outlet is in fluid communication with the spray nozzle inlet;
m) a trigger slidably or pivotally mounted in the handle portion, wherein the trigger controls the movement of the valve between the open position and the closed position;
n) a motor powered pump within the housing having a pump inlet and a pump outlet, wherein the pump inlet is in fluid communication with the hose connector, and wherein the pump outlet is in fluid communication with the valve inlet;
o) a battery detachably coupled to an outside surface of the housing; and
p) a pump switch coupled to the housing, wherein the pump switch is electrically coupled to the motor powered pump and the battery.

2. The power sprayer of claim 1 further comprising a movable panel forming a wall of the housing, wherein the movable panel comprises a dispenser for dispensing a liquid.

3. The power sprayer of claim 2 further comprising a dispenser switch configured to be operable between an open position for opening the dispenser and a closed position for closing the dispenser, wherein the liquid is a soap or detergent.

4. The power sprayer of claim 2 further comprising a sight gauge for observing the level of the liquid in the dispenser.

5. The power sprayer of claim 2, wherein the dispenser is in fluid communication with the spray nozzle inlet, the valve outlet, the valve inlet or the pump outlet.

6. The power sprayer of claim 1, wherein the spray nozzle is a compound nozzle, wherein the compound nozzle comprises a plurality of nozzles, and wherein each of the nozzles is configured to deliver a set of spray characteristics different from the other nozzles.

7. The power sprayer of claim 1, wherein the spray nozzle comprising a rotatable nozzle having a plurality of orifices, and wherein each of the orifices is configured to deliver a set of spray characteristics different from the other orifices.

8. The power sprayer of claim 1, wherein the spray nozzle is a two-fluid nozzle having a spray nozzle outlet and two spray nozzle inlets, wherein the valve outlet is in fluid communication with one of the spray nozzle inlets and the dispenser is in fluid communication with the other spray nozzle inlet.

9. The power sprayer of claim 1 further comprising a trigger guide coupled to the handle portion, wherein the trigger slidably runs on the trigger guide.

10. The power sprayer of claim 1, wherein the pump inlet is connected by a first hose to the hose connector and the pump outlet is connected by a second hose to the valve inlet.

11. The power sprayer of claim 10, wherein the inside diameter of each of the first and second hoses is independently 0.375 inches (9.525 mm), 0.5 inches (12.7 mm), or 0.625 inches (15.875 mm).

12. The power sprayer of claim 1, wherein the battery is a rechargeable battery.

13. The power sprayer of claim 12, wherein the rechargeable battery comprises one or a plurality of lithium-ion batteries or cells.

14. The power sprayer of claim 1 further comprising an electrical contact base at a bottom portion of the housing, wherein the battery detachably coupled to the housing by coupling with the outside surface of the electrical contact base.

15. The power sprayer of claim 1, wherein the motor powered pump is configured to provide at the spray nozzle outlet or the pump outlet a water pressure of at least 60 psi, at least 80 psi, at least 100 psi, at least 120 psi or at least 130 psi and a flow rate of at least 1 liter per minute, at least 2 liters per minute, at least 3 liters per minute, at least 4 liters per minute, or at least 5 liters per minute.

16. The power sprayer of claim 1, wherein the valve is a plunger valve or a shuttle valve.

17. The power sprayer of claim 1 further comprising a pressure sensor coupled to the handle portion for sensing the gripping pressure by an operator on the sensor or the trigger.

18. The power sprayer of claim 1 further comprising an external hose connected with the hose connector for siphoning water from a container or a natural body of water.

19. The power sprayer of claim 1 further comprising a splash guard between the hose connector and the battery for keeping water away from the battery.

20. The power sprayer of claim 1, wherein the power sprayer works like a standard hose sprayer when the pump is not powered by the battery.
